(19) United States
(12) Patent Application Publication
(10) Pub. No.: US 2017/0106631 A1
(43) Pub. Date: Apr. 20, 2017

(54) MULTI-LAYER POLYMER SHEETS WITH SEPARATABLE LAYERS FOR COVERING A GREENHOUSE

(71) Applicant: AT FILMS INC., Edmonton (CA)

(72) Inventors: Xiaojiang Zhang, Edmonton (CA); Calvin Mazurenko, Sherwood Park (CA); Trevor Keanie, Edmonton (CA)

(73) Assignee: AT FILMS INC., Edmonton (CA)

(21) Appl. No.: 15/294,145

(22) Filed: Oct. 14, 2016

Related U.S. Application Data
(60) Provisional application No. 62/242,793, filed on Oct. 16, 2015.

(51) Int. Cl. B32B 27/08; B32B 27/30; B32B 27/18; B32B 27/32

(52) U.S. Cl. CPC B32B 27/08; B32B 27/32; B32B 27/306; B32B 27/18; B32B 2419/00; B32B 2307/304

(57) ABSTRACT

A multilayer film for covering an agricultural structure is provided. The film has an upper layer comprised of a polymeric material, a lower layer comprised of a polymeric material and a core layer provided between the upper layer and the lower layer and formed of a material at least partially chemically incompatible with the polymeric material making up the upper layer and the lower layer. The film can be installed on a structure and then a gas can be introduced between at least one of: the upper layer and the core layer; and the lower layer and the core layer to separate the upper layer and lower layer physically apart.

### RELATED APPLICATION

The present application claims the benefit of U.S. Provisional Application No. 62/242,793, filed Oct. 16, 2015, which is hereby incorporated herein in its entirety by reference.

### TECHNICAL FIELD

The present invention relates to a multi-layer thermoplastic film structure having layers that can be separated for use in horticultural and agricultural applications, including greenhouses and other structures. More particularly, this invention provides a multi-layer greenhouse covering structure in which at least two adjacent substantially chemically-unbonded films are included and can be separated from one another.

### BACKGROUND

For many years composite or multi-layered thermoplastic films have been widely used in horticultural and agricultural applications including greenhouses. One of the most significant inventions is the double-film greenhouse structure in which inflated air is kept between two individual films for desired thermal insulation. The installation of the double-film greenhouse has several long-existing disadvantages including: 1) long installation time; 2) uncontrolled inflation rate; 3) being labour/cost consuming; and 4) being hard to install in windy conditions.

More recently, it has been suggested in WO2012/143289 and WO2014/023479 that a single multi-layer film can be used where the film contains adjacent layers that have an average delamination strength of less than 250 ml g/15 mm when measured using ASTM D-1876. Air is then injected between the two or more film layers which are inflated with gas to provide thermal insulation.

However, the multi-layer films using the materials described in WO2012/143289 and WO2014/023479 suffer a number of disadvantages. Some of the suggested materials are not very flexible and this can make installation troublesome since they are not easy to stretch both for installation and when air is provided between the layers. For many of these materials, making a layer with these materials in the sizes described in these references, where the layer itself acts as a structural layer, can increase the cost of the film substantially because the material used and the thickness of the layer it is used in will increase the cost of the multi-layer film substantially.

### SUMMARY

In a first aspect, a multilayer film for covering an agricultural structure is provided. The film has an upper layer comprised of a polymeric material, a lower layer comprised of a polymeric material and a core layer provided between the upper layer and the lower layer and formed of a material at least partially chemically incompatible with the polymeric material making up the upper layer and the lower layer.

In a further aspect, the upper layer and the lower layer of the film are made up of polyolefin and the material of the core layer comprises a blend of polyolefin resins and at least one of: vinyl alcohol polymer; vinyl alcohol copolymer; and polypropylene.

In a further aspect, a method of installing a film on a structure is provided. The method includes providing a multilayer film having an upper layer comprised of a polymeric material, a lower layer comprised of a polymeric material and a core layer provided between the upper layer and the lower layer and formed of a material at least partially chemically incompatible with the polymeric material making up the upper layer and the lower layer. The film is then installed on a structure and a gas is introduced between at least one of: the upper layer and the core layer; and the lower layer and the core layer. After the gas has caused the upper layer and the lower layer to be displaced away from each other, the core layer can be removed from between the upper layer and the lower layer.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

A preferred embodiment of the present invention is described below with reference to the accompanying drawings, in which:

FIG. 1 illustrates a schematic illustration of a cross section of a multi-layer thermoplastic film.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

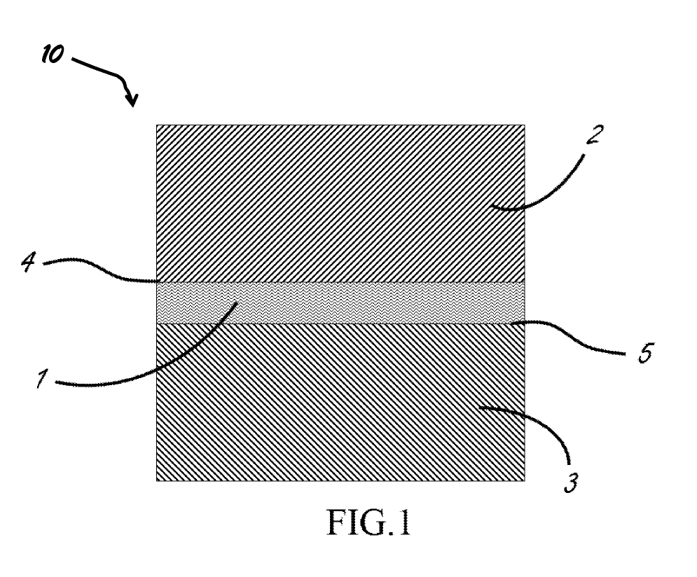

FIG. 1 illustrates a thermoplastic multi-layer film 10 than can include a core layer 1, an upper layer 2 and a lower layer 3. A first layer interface 4 occurs between the upper layer 2 and the core layer 1 and a second layer interface 5 occurs between the lower layer 3 and the core layer 1. Either one or both of the first layer interface 4 and the second layer interface 5 can lack adhesion between the adjacent layers because of the chemical incompatibility of the material making up the adjacent layers. For the first layer interface 4, that would be chemical incompatibility of the materials making up the upper layer 2 and the material making up the core layer 1. For the second layer interface 5, that would be chemical incompatibility of the materials making up the lower layer 3 and the core layer 1. This degree of chemical incompatibility between the core layer 1 and the adjacent upper layer 2 or lower layer 3 can allow a force-induced separation or self-separation so that the upper layer 2 and/or lower layer 3 can be delaminated or separated from the core layer 1.

The multi-layer film 10 can provide a simple and effective double-film greenhouse installation. Compared to a conventional double-film greenhouse installation where two or more separate sheets are installed separately in place on the greenhouse, with first one being installed and then the second sheet being installed over the first sheet. Air can then blown between the two separate sheets to separate them with a layer of air, the present multi-layer film 10 provides easier installation. The single multi-layer film 10 typically has a heavier weight than each individual separate sheet (usually over 10 mil thick comparing to 4-6 mil for conventional separate films) and therefore can provide significantly better management especially in windy conditions. Additionally, the time for installation can be significantly shortened because only the single multi-layer film 10 must be installed rather than a number of different separate sheets one after the other.

The multi-layer film 10 can: (i) have weak bonds (mainly the van der Waals force) among at least two co-extruded layers 1, 2, 3; (ii) have optical properties required for green house applications including the light transmission, haze, and clarity, etc.; (iii) have decent physical properties required for greenhouse applications including tear resistance, puncture resistance, and elongation, etc.; (iv) be relatively easy to produce; and (v) be cost-effective.

In operation, the single multi-layer film 10 can be installed on the greenhouse structure and a greenhouse air system used to separate the upper layer 2 and the lower layer 3 with a layer of air that has been introduced between the upper layer 2 and the lower layer 3. The greenhouse air system can be an air pump or air fan that is used to introduce air between the upper layer 2 and the lower layer 3. The air can be introduced in the first layer interface 4, the second layer interface 5 or both depending on the material used for the core layer 1, upper layer 2 and lower layer 3 or how the installer would like it to work.

The upper layer 2 and the lower layer 3 are the functional structures of the multi-layer film 10 used as a greenhouse covering system. In one aspect, the core layer 1 can be attached to either the upper layer 2 or the lower layer 3. When co-extruded with a minimized thickness, the core layer 1 attached but not bonded to both the upper layer 2 and lower layer 3 will remain nearly invisible after the inflation of air between the upper layer 2 or the lower layer 3 and the core layer 1. Usually, the core layer 1 will stay adjacent to one of the two main layers and be pressed against the other layer. However, the core layer 1 can be freed from both the upper layer 2 and the lower layer 3 and even removed or pulled out from between the upper layer 2 and the lower layer 3 and removed all together from the greenhouse. In other cases when the core layer 1 is bonded to either the upper layer 2 or the lower layer 3 using tie resins, the thickness of the core layer 1 is not critical.

Both the upper layer 2 and the lower layer 3 can be a composite or laminate plastic film and can include multiple layers of material forming the layer. A variety of polymeric materials can be used in the upper layer 2 and the lower layer 3. In one aspect, polymeric materials widely used in the horticultural/agricultural industries can be used. These polymeric materials can include polyolefin such as polyethylene (PE) and copolymers of ethylene and vinyl acetate (EVA polymers). “Polyethylene” can include polyethylene homopolymers and copolymers which are commonly known as Low Density Polyethylene (LDPE), Linear Low Density Polyethylene (LLDPE), Metallocene Polyethylene (mPE), Medium Density Polyethylene (MDPE), High Density Polyethylene (HDPE), Very Low Density Polyethylene (VLDPE), Ultra Low Density Polyethylene (ULDPE), and polyethylene plastomers.

The core layer 1 is primarily responsible for providing the layer separation properties for the multi-layer film 10. Although the core layer 1 can be made of a homogeneous material it could also be a blend of materials, vinyl alcohol polymer or vinyl alcohol copolymer and have a multilayer structure made up of these different materials. The material making up the core layer 1 is chemically incompatible with either one of or both of the material making up the upper layer 2 and the lower layer 3.

In one aspect, the core layer 1 can be formed from vinyl alcohol polymers/copolymers. The vinyl alcohol polymer/copolymer making up the core layer 1 could include poly(vinyl alcohol-co-ethylene) or poly(vinyl alcohol) suitable for extrusion. These materials in the core layer 1 can be desirable because they are substantially chemically incompatible with polyolefin including polyethylene. By using these materials in the core layer 1, polyolefin material could be used in either or both of the upper layer 2 and the lower layer 3. A core layer 1 containing vinyl alcohol polymers/copolymers is capable of separating the upper layer 2 and lower layer 3 made from a polyolefin material easily. Vinyl alcohol polymer/copolymer lacks the elasticity found in polyethylene (such as LLDPE) and EVA which can be used as the main material in upper layer 2 and lower layer 3. The film is pulled and stretched during installation and the elasticity differences between the vinyl alcohol polymer and copolymer in the core layer 1 and the PE/EVA in the upper layer 2 and the lower layer 3 helps the layer separation.

Alternatively, the core layer 1 could be formed from polypropylene. Polypropylene is substantially chemically incompatible with polyethylene allowing either or both of the upper layer 2 and lower layer 3 to be formed with polyethylene and separated from a core layer 1 containing polypropylene.

The upper layer 2 and the lower layer 3 can have any suitable chemical additive used for film applications added to them to provide desirable properties in the finished multi-layer film 10 and improve its operation as a greenhouse or other agricultural cover. These chemical additive can include slip additives, UV absorber additives, light stabilizer additives, anti-fog, anti-condensate additives, processing aid additives, color additives, anti-block additives, etc. These chemical additives can be used in the polymer blend making up the upper layer 2 and/or lower layer 3 to achieve the desired functionalities of the finished multi-lawyer film 10.

The core layer 1 may be free of chemical additives. This may especially be true if it is intended that some installers may remove the core layer 1 altogether from between the upper layer 2 and the lower layer 3 during installation of the film 10. The core layer 1 also does not need to have the same optical properties required for green house applications (i.e. light transmission, haze, clarity, etc.) as the upper layer 2 and the lower layer 3 if it is to be removed from between the upper layer 2 and the lower layer 3 after the film 10 is installed in place and as a result, the core layer 1 may be formed without having these same optical properties.

From a cost effectiveness standpoint, especially considering the much higher cost of vinyl alcohol polymer/copolymers and polypropylene compared to the cost of polyethylene, the thickness of the core layer 1 should ideally be minimized. Use of a very thin core layer 1 made of vinyl alcohol polymer/copolymer or polypropylene provides a low cost approach for making a multi-layer greenhouse covering system. In one aspect, the thickness of the core layer 1 can be 0.5 to 5% of the overall thickness of the multi-layer film 10. Depending on the extrusion equipment's capability, the core layer thickness is ideally minimized as small as it can be relative to the thickness of the upper layer 2 and the lower layer 3. For example, in one aspect, the thickness of the core layer 1 can be from 1 μm to 20 μm while the thickness of the upper layer 2 and the lower layer 3 is between 100 μm and 160 μm.

The use of vinyl alcohol polymers/copolymers also lead to a flexible size range for the film. For example, using EVAL E171 grade resin as the material in the core layer 1, a bubble circumference ranging from 20 FT to 50 FT with a gauge ranging from 3 mil to 15 mil can be achieved on a 1.6 meter diameter die.

In a further aspect, the separation rate of the upper layer 2 and lower layer 3 can be finely controlled by tuning the chemical incompatibility between the upper layer 2 and the core layer 1 and/or the lower layer 3 and the core layer 1 by blending different materials to form the core layer 1 and/or the upper layer 2 and the lower layer 3. For instance, polymer X is incompatible with polymer Y but compatible with polymer Z. To adjust the affinity or incompatibility between a layer made of X and a second layer attached to it, a blend of Z and Y can be used. By choosing the blend for these layers, the incompatibility between the core layer 1 and the upper layer 2 and incompatibility between the core layer 1 and the lower layer 3 can be set and this chosen incompatibility used, along with the rate of air introduced between the layers, to result in a controlled film separation rate for the multi-layer film 10 in place on the greenhouse structure. Such an in-situ control of the separation rate is used to adjust and monitor the internal pressure of the greenhouse covering system with ease. A controlled film separation rate during installation process is desired for better monitoring and manipulating the pressure between the two films on a greenhouse.

The core layer 1 can be formed of a blend of vinyl alcohol polymer/copolymer or polypropylene and polyolefin resins. By varying the ratio of vinyl alcohol polymer/copolymer or polypropylene to polyolefin resins in the core layer 1, the adhesion to the upper layer 2 and/or lower layer 3 can be fine-tuned. If the upper layer 2 and/or lower layer 3 are formed with polyolefin resins, the less chemical incompatibility occurs the more polyolefin resins that are blended with the vinyl alcohol polymer/copolymer in the core layer 1 and the more the upper layer 2 and/or lower layer 3 will adhere with the core layer 1. By carefully choosing the ratio of the of vinyl alcohol polymer/copolymer to polyolefin resins in the core layer 1, the amount of adhesion that occurs between the upper layer 2 and/or the lower layer 3 and the core 1 can be controlled and thereby the ease with which the upper layer 2 and lower layer 3 will separate from the core layer 1 and the amount of air that is required to do so.

Because of their very different chemical and physical properties, for example the melting temperature, vinyl alcohol polymer/copolymers and polyolefin resins are normally considered to be incompatible and it is believed in the industry that they cannot be blended in one layer. More specifically, as an example, in order to co-extrude poly(vinyl alcohol-co-ethylene) and polyethylene separately in different layers, special blown extrusion procedures must be applied: i) the blow-up-ratio must be controlled because of the different cooling rates between the two polymers; ii) different temperatures must be applied on the extruders to melt the resins because of their different melting temperatures; iii) the internal bubble cooling rate must be tuned to be suitable for both polymers. If poly(vinyl alcohol-co-ethylene) and polyethylene are blended, gels and holes will normally form on the bubble. However, poly(vinyl alcohol-co-ethylene) can be blended and co-extruded with olefin-acetate/acrylate copolymers (e.g. EVA/EEA), but the vinyl alcohol polymer/copolymers including poly(vinyl alcohol-co-ethylene) and poly(vinyl alcohol) must have a melt index no greater than 100 g/10 min (lowest molecular weight).

Widely utilized in the food packing industry for their excellent gas barrier properties, the vinyl alcohol polymers/copolymers are commercially available and fairly extrusion-friendly. For example, the Japanese company Kuraray produces poly(vinyl alcohol-co-ethylene) resins with a vinyl mol % ranging from 24% to 48% under the trade name EVAL™. EVAL resins with higher vinyl mol % are suitable to be co-extruded with polyethylene which is the single most common material for horticultural/agricultural film applications. More importantly, because of their great processability in blown extrusion, the EVAL resins can be blended with other polymers such as PE/EVA/EEA to build the core layer 1 in order to manipulate the layer incompatibility.

If the amount of adhesion between the core layer 1 and the upper layer 2 and lower layer 3 is low enough or if the core layer 1 does not adhere at all to the upper layer 2 and the lower layer 3. The core layer 1 can be removed from between the upper layer 2 and the lower layer 3 during installation. After the multi-layer film 10 is installed in position, such as covering a greenhouse structure, a layer of air can be introduced between the core layer 1 and/or upper layer 2 and the lower layer 3. This air layer will cause the upper layer 2 and the lower layer 3 to physically move away from one another. With the upper layer 2 and the lower layer 3 separated by the air layer, if the core layer 1 is very weakly adhered or does not adhere at all to either the upper layer 2 or the lower layer 3 it can be removed from between the upper layer 2 and the lower layer 3. If the film 10 is applied on an angle, i.e. the roof of the greenhouse roof has a relatively sharp slope, the core layer 1 may separate from the upper layer 2 and the lower layer 3 and slide down the slope to bunch up at the bottom of the slope from gravity alone. This would result in the core layer 1 being removed from the upper layer 2 and the lower layer 3; only being present between these layers along one side of the film 10. Additionally, the upper layer 2 and the lower layer 3 could in some cases be separated by an installer on one side of the film 10 and the core layer 1 pulled out from between the upper layer 2 and the lower layer 3. This could be done if the film 10 has been installed at an angle and the core layer 1 has slid down and bunched up at one side of the film 10 or the installer could separate the upper layer 2 and the lower layer 3 forming an opening at one side of the film 10 and pulling the core layer 1 out from between the upper layer 2 and the lower layer 3 through this opening.

If the core layer 1 is meant to be removed during the installation process of the film 10 then it is not as important that the core layer 1 have optical properties required for green house applications including the light transmission, haze, and clarity, etc. Light entering the greenhouse after installation of the film 10 will not have to pass through this core layer 1 since it will be removed during installation and therefore the properties of the core layer 1 can be chosen without having regard to its optical properties which could result in the core layer 1 being cheaper to make.

As described above, the chemically incompatible interfaces are achieved by using incompatible materials in different layer. For instance, when polyolefin or more specifically, polyethylene is used as the main component for the upper layer 2 and/or the lower layer 3 while vinyl alcohol polymer/copolymer is used in the core layer 1, the incompatible interfaces 4 and 5 can separate the entire film 10 into its separate layers.

### EXAMPLES

### Example 1

A multilayer greenhouse covering film having two main layers and one thin core layer was prepared by co-extruding polyolefins and vinyl alcohol polymer/copolymers. The film produced included two (2) chemically incompatible layer interfaces.

Main ingredients for the upper layer: PE and/or EVA and/or EEA.

Main ingredients for the core layer: up to 100% vinyl alcohol polymers/copolymers including poly(vinyl alcohol-co-ethylene) and poly(vinyl alcohol).

Main ingredients for the lower layer: PE and/or EVA and/or EEA.

Typical structure for a 7 layer film:

| Layer # | Layer % | Main Ingredients |
|---|---|---|
| 1 (Upper) | 20.5% | PE |
| 2 (Upper) | 20% | PE |
| 3 (Upper) | 8% | PE |
| 4 (Core) | 3% | Pure vinyl alcohol polymers/copolymers or blends |
| 5 (Lower) | 8% | PE |
| 6 (Lower) | 26.5% | PE; EVA |
| 7 (Lower) | 14% | PE; EVA |

Typical structure for a 5 layer film:

| Layer # | Layer % | Main Ingredients |
|---|---|---|
| 1 (Upper) | 24.5% | PE |
| 2 (Upper) | 24% | PE |
| 3 (Lower) | 3% | Pure vinyl alcohol polymers/copolymers or blends |
| 4 (Lower) | 18.5% | PE |
| 5 (Lower) | 30% | PE; EVA |

Typical structure for a 3 layer film:

| Layer # | Layer % | Main Ingredients |
|---|---|---|
| 1 (Upper) | 48.5% | PE |
| 2 (Core) | 3% | Pure vinyl alcohol polymers/copolymers or blends |
| 3 (Lower) | 48.5% | PE; EVA |

Typical physical and optical properties of the above film were as follows:

Thickness - - - 5.82 mil (upper layer); 0.36 mil (core layer); 5.82 mil (lower layer)

Light Transmission - - - 91.5% (upper layer); 91% (lower layer)

Haze - - - 23% (upper layer); 25% (lower layer)

The much heavier upper layers 2 and lower layers 3 comparing to the thin core layer 1 leads to easier layer separation of the multi-layer film 10. After the layer separation, the core layer 1 will attach but not bond to one of the two main layers 2, 3. Because of the lack of adhesion, the core layer 1 can also be pulled out from the greenhouse covering during the separation process.

### Example 2

A multilayer greenhouse covering film having two main layers and one thin core layer was prepared by co-extruding polyolefin and vinyl alcohol polymer/copolymers. The film produced included one (1) chemically incompatible layer interfaces.

Main ingredients for the upper layer: PE and/or EVA and/or EEA.

Main ingredients for the core layer: up to 100% vinyl alcohol polymers/copolymers including poly(vinyl alcohol-co-ethylene) and poly(vinyl alcohol).

Main ingredients for the lower layer: PE and/or EVA and/or EEA.

Bonding chemicals (tie resin) were used in either the upper layer or the lower layer. An example of the tie resin is DuPont Bynel® 41E710.

Typical structure for a 7 layer film:

| Layer # | Layer % | Main Ingredients |
|---|---|---|
| 1 (Upper) | 19.5% | PE |
| 2 (Upper) | 19.5% | PE |
| 3 (Upper) | 8% | PE; tie resin |
| 4 (Core) | 3% | Pure vinyl alcohol polymers/copolymers or blends |
| 5 (Lower) | 8% | PE |
| 6 (Lower) | 26.5% | PE; EVA |
| 7 (Lower) | 15.5% | PE; EVA |

Typical structure for a 5 layer film:

| Layer # | Layer % | Main Ingredients |
|---|---|---|
| 1 (Upper) | 23% | PE |
| 2 (Upper) | 24% | PE; tie resin |
| 3 (Core) | 3% | Pure vinyl alcohol polymers/copolymers or blends |
| 4 (Lower) | 20% | PE |
| 5 (Lower) | 30% | PE; EVA |

Typical structure for a 3 layer film:

| Layer # | Layer % | Main Ingredients |
|---|---|---|
| 1 (Upper) | 47% | PE; EVA |
| 2 (Core) | 3% | Pure vinyl alcohol polymers/copolymers or blends |
| 3 (Lower) | 50% | PE; EVA |

Typical physical and optical properties of the above film were as follows:

Thickness - - - 5.64 mil (upper layer); 0.36 mil (core layer); 6.0 mil (lower layer)

Light Transmission - - - 91% (upper layer); 91% (lower layer)

Haze - - - 23% (upper layer); 25% (lower layer)

After the layer separation, the core layer will only bond to one of the main layers where the bonding material is applied to.

### Example 3

A multilayer greenhouse covering film having two main layers and one core layer was prepared by co-extruding polyolefin and vinyl alcohol polymer/copolymers. The film produced included one (1) chemically incompatible layer interfaces.

Main ingredients for the upper layer: blends of polyethylene, EVA/EEA and vinyl alcohol polymers/copolymers.

Main ingredients for the core layer: blends of polyethylene, EVA/EEA and vinyl alcohol polymers/copolymers.

Main ingredients for the lower layer: Polyethylene and/or EVA/EEA.

Bonding chemicals (tie resins) were not necessarily required when use a blend containing vinyl alcohol polymers/copolymers.

Typical structure for a 7 layer film:

| Layer # | Layer % | Main Ingredients |
|---|---|---|
| 1 (Upper) | 15% | PE; EVA/EEA; vinyl alcohol |
| | | polymers/copolymers |
| 2 (Upper) | 14.5% | PE; EVA/EEA; vinyl alcohol |
| | | polymers/copolymers |
| 3 (Upper) | 8% | PE; EVA/EEA; vinyl alcohol |
| | | polymers/copolymers |
| 4 (Core) | 12.5% | PE; EVA/EEA; vinyl alcohol |
| | | polymers/copolymers |
| 5 (Lower) | 8% | PE |
| 6 (Lower) | 26.5% | PE; EVA |
| 7 (Lower) | 15.5% | PE; EVA |

Typical structure for a 5 layer film:

| Layer # | Layer % | Main Ingredients |
|---|---|---|
| 1 (Upper) | 20% | PE; EVA/EEA; vinyl alcohol |
| | | polymers/copolymers |
| 2 (Upper) | 17.5% | PE; EVA/EEA; vinyl alcohol |
| | | polymers/copolymers |
| 3 (Core) | 12.5% | PE; EVA/EEA; vinyl alcohol |
| | | polymers/copolymers |
| 4 (Lower) | 20% | PE |
| 5 (Lower) | 30% | PE; EVA |

Typical structure for a 3 layer film:

| Layer # | Layer % | Main Ingredients |
|---|---|---|
| 1 (Upper) | 37.5% | PE; EVA/EEA; vinyl alcohol |
| | | polymers/copolymers |
| 2 (Core) | 12.5% | PE; EVA/EEA; vinyl alcohol |
| | | polymers/copolymers |
| 3 (Lower) | 50% | PE; EVA |

Typical physical and optical properties of the above film were as follows:

Thickness - - - 4.5 mil (upper layer); 1.5 mil (core layer); 6.0 mil (lower layer)

Light Transmission - - - 91% (upper layer); 91% (lower layer)

Haze - - - 23% (upper layer); 26% (lower layer)

### Example 4

A multilayer greenhouse covering film having two main layers and one thin core layer was prepared by co-extruding PE and PP.

Main ingredients for the upper layer: PE and/or EVA and/or EEA.

Main ingredients for the core layer: up to 100% polypropylene.

Main ingredients for the lower layer: PE and/or EVA and/or EEA.

Typical structure for a 7 layer film:

| Layer # | Layer % | Main Ingredients |
|---|---|---|
| 1 (Upper) | 20.5% | PE |
| 2 (Upper) | 20% | PE |
| 3 (Upper) | 8% | PE |
| 4 (Core) | 3% | Pure PP or blends |
| 5 (Lower) | 8% | PE |
| 6 (Lower) | 26.5% | PE; EVA |
| 7 (Lower) | 14% | PE; EVA |

Typical structure for a 5 layer film:

| Layer # | Layer % | Main Ingredients |
|---|---|---|
| 1 (Upper) | 24.5% | PE |
| 2 (Upper) | 24% | PE |
| 3 (Lower) | 3% | Pure PP or blends |
| 4 (Lower) | 18.5% | PE |
| 5 (Lower) | 30% | PE; EVA |

Typical structure for a 3 layer film:

| Layer # | Layer % | Main Ingredients |
|---|---|---|
| 1 (Upper) | 48.5% | PE |
| 2 (Core) | 3% | Pure PP or blends |
| 3 (Lower) | 48.5% | PE; EVA |

Typical physical and optical properties of the above film were as follows:

Thickness - - - 5.82 mil (upper layer); 0.36 mil (core layer); 5.82 mil (lower layer)

Light Transmission - - - 91.5% (upper layer); 91% (lower layer)

Haze - - - 23% (upper layer); 25% (lower layer)

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A multilayer film for covering an agricultural structure, the film comprising:
an upper layer comprised of a polymeric material;
a lower layer comprised of a polymeric material; and
a core layer provided between the upper layer and the lower layer and formed of a material at least partially chemically incompatible with the polymeric material making up the upper layer and the lower layer.

2. The film of claim 1 wherein the polymeric material in the upper layer and the polymeric material in the lower layer includes polyolefin and the material of the core layer includes at least one of: vinyl alcohol polymer; and vinyl alcohol copolymer.

3. The film of claim 2 wherein the polyolefin includes at least one of: polyethylene; copolymers of ethylene; and vinyl acetate.

4. The film of claim 1 wherein the polymeric material in the upper layer and the lower layer includes polyethylene and the material of the core layer includes polypropylene.

5. The film of claim 4 wherein the polyethylene can include at least one of: polyethylene homopolymer; polyethylene copolymer, Linear Low Density Polyethylene (LLDPE), Metallocene Polyethylene (mPE), Medium Density Polyethylene (MDPE), High Density Polyethylene (HDPE), Very Low Density Polyethylene (VLDPE), Ultra Low Density Polyethylene (ULDPE), and polyethylene plastomers.

6. The film of claim 1 wherein the upper layer comprises at least one chemical additive selected from the group of: slip additives; UV absorber additives; light stabilizer additives; anti-fog; anti-condensate additives; processing aid additives; color additives; anti-block additives.

7. The film of claim 1 wherein the lower layer comprises at least one chemical additive selected from the group of: slip additives; UV absorber additives; light stabilizer additives; anti-fog; anti-condensate additives; processing aid additives; color additives; anti-block additives.

8. The film of claim 6 wherein the core layer is free of additives.

9. The film of claim 7 wherein the core layer is free of additives.

10. The film of claim 1 wherein the core layer has a thickness that is between 0.5% and 5% of a thickness of the film.

11. The film of claim 1 wherein the polymeric material in the upper layer and the lower layer comprises polyolefin and the material of the core layer comprises a blend of polyolefin resins and at least one of: vinyl alcohol polymer; vinyl alcohol copolymer; and polypropylene.

12. A method of installing a film of claim 1, the method comprising:
providing a multilayer film in accordance with claim 1;
installing the film on a structure;
introducing a gas between at least one of: the upper layer and the core layer; and the lower layer and the core layer; and
after the gas has caused the upper layer and the lower layer to be displaced away from each other, removing the core layer from between the upper layer and the lower layer.

13. The method of claim 14 wherein the core layer is removed by separating the upper layer and the lower layer on a side of the multilayer film to define an opening and pulling the core layer through the opening.

14. The method of claim 14 further comprising installing the film on the structure at an angle and allowing the core layer to slide down the angled film to a side of the film when the gas is introduced.
